(19) United States
(12) Patent Application Publication
(10) Pub. No.: US 2015/0113753 A1
(43) Pub. Date: Apr. 30, 2015

(54) Windshield Cleaning Apparatus

(71) Applicant: Leasa Barnwell-Williams, Fayetteville, NC (US)

(72) Inventor: Leasa Barnwell-Williams, Fayetteville, NC (US)

(21) Appl. No.: 14/317,494

(22) Filed: Jun. 27, 2014

Related U.S. Application Data
(63) Continuation-in-part of application No. 14/064,114, filed on Oct. 26, 2013.

(51) Int. Cl. B60S 1/48; B60S 1/52; B60S 1/50

(52) U.S. Cl. CPC B60S 1/481; B60S 1/50; B60S 1/52; B60S 1/482
USPC 15/250.04

(57) ABSTRACT

A windshield cleaning apparatus for use with a vehicle having an engine compartment, a windshield, a pair of windshield wipers, and a battery includes first and second reservoirs situated in the engine compartment of the vehicle. The first and second reservoirs are configured to contain a traditional windshield cleaning fluid and a deicing fluid, respectively. A pump is connected to the battery and operatively coupled to the first and second reservoirs so as to selectively pump respective fluids out of respective reservoirs when energized by the battery. An outlet port is proximate each windshield wiper member of the vehicle. A tubing member interconnects the first reservoir and the second reservoir with respective outlet ports and through which a respective fluid is urged when the pump is energized. An actuator is electrically connected to the battery and configured to energize the pump to urge the respective fluid into the tubing member.

### REFERENCE TO RELATED APPLICATIONS

This application claims the benefit of non-provisional application Ser. No. 14/064,114 filed on Oct. 26, 2013, titled “Deicing Device and Method” and which is incorporated herein by reference in its entirety.

### BACKGROUND OF THE INVENTION

The present invention relates generally to vehicle windshield wiping assemblies and, more particularly, to a windshield cleaning apparatus that selectively dispenses traditional windshield cleaning fluid or a deicing solution onto a windshield according to a user selection.

Traditionally, a motor vehicle has a pair of windshield wipers in fluid communication with a reservoir configured to contain a cleaning solution of water combined with a solvent or detergent. When the windshield becomes dirty, a driver can activate the wipers having one or more nozzles configured to spray the cleaning solution on the windshield where the motion of the wipers cleans the windshield.

Although traditional wipers are presumably effective for cleaning a dirty windshield, they are generally ineffective to clear ice or snow off of a traditional windshield wiper assembly. When a windshield is completely or partially covered by ice or snow, a driver must first scrape the ice or snow from the exterior of the windshield.

Therefore, it would be desirable to have a windshield cleaning apparatus having a pair of reservoirs configured to contain a traditional windshield cleaning solution and a deicing solution, respectively. Further, it would be desirable to have a windshield cleaning apparatus having a selection module that enables a driver to select which solution is dispensed onto the windshield.

### SUMMARY OF THE INVENTION

A windshield cleaning apparatus according to the present invention for use with a vehicle having an engine compartment, a windshield, a pair of windshield wiper members, and a battery includes a first and second reservoir situated in the engine compartment of the vehicle. The first reservoir is configured to contain a traditional windshield cleaning fluid and the second reservoir is configured to contain a deicing fluid. A pump is connected to the battery and operatively coupled to the first reservoir and to the second reservoir so as to selectively pump respective fluids out of respective reservoirs when energized by the battery. An outlet port is proximate each windshield wiper member of the vehicle. A tubing member interconnects the first reservoir and the second reservoir with respective outlet ports and through which a respective fluid is urged when the pump is energized. An actuator is electrically connected to the battery and configured to energize the pump to urge the respective fluid into the tubing member.

Therefore, a general object of this invention is to provide a windshield cleaning apparatus having a pair of reservoirs configured to contain a traditional windshield cleaning solution and a deicing solution, respectively.

Another object of this invention is to provide a windshield cleaning apparatus, as aforesaid, that replaces a traditional singular windshield wiper fluid container positioned in the engine compartment of a vehicle.

Still another object of this invention is to provide a windshield cleaning apparatus, as aforesaid, having an input device positioned in the driver cabin of the vehicle that enables a driver to select either the traditional or deicing solution to be dispensed onto the windshield.

Yet another object of this invention is to provide a windshield cleaning apparatus, as aforesaid, that does not rust or deteriorate over time.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a windshield cleaning apparatus according to a preferred embodiment of the present invention installed in the engine compartment of a vehicle;

FIG. 2 is a perspective view of the windshield cleaning apparatus as in FIG. 1 removed from the engine compartment;

FIG. 3 is a perspective view of an input device of the windshield cleaning apparatus;

FIG. 4 is a block diagram representation of the windshield cleaning apparatus; and

FIG. 5 is a perspective view of windshield wipers of the vehicle in use with the windshield cleaning apparatus.

### DESCRIPTION OF THE PREFERRED EMBODIMENT

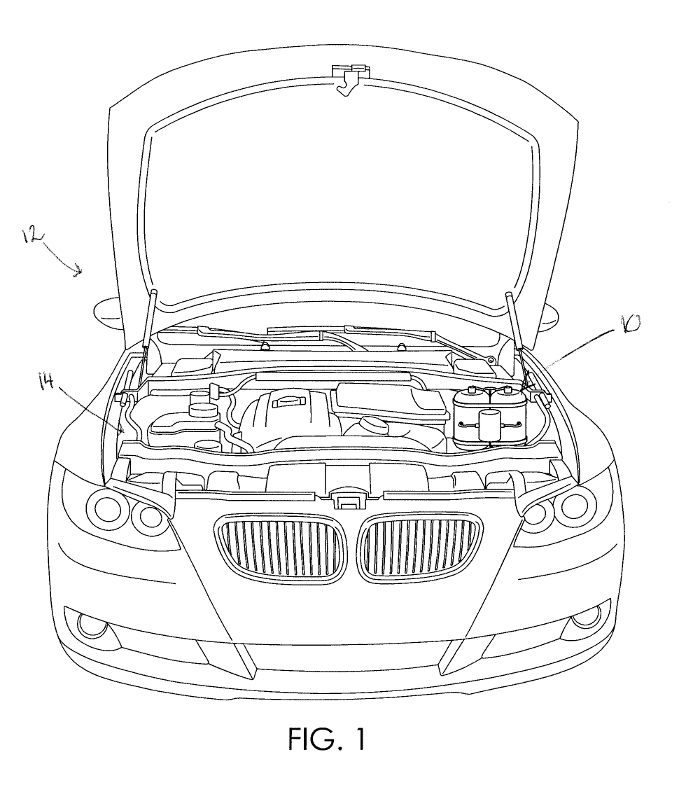

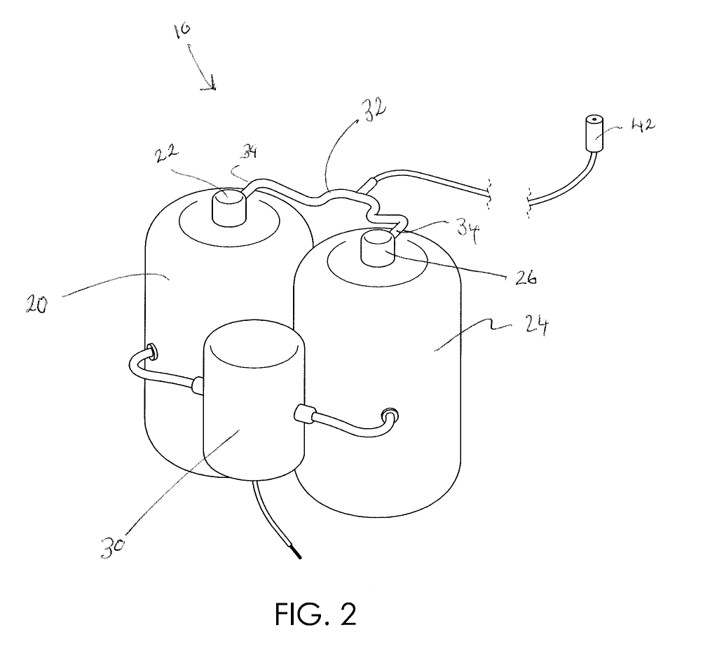

A windshield cleaning apparatus according to a preferred embodiment of the present invention will now be described in details with reference to FIGS. 1 to 5 of the accompanying drawings. The windshield cleaning apparatus 10 includes a first reservoir 20, a second reservoir 24, a pump 30, and a tubing member 32 interconnecting the reservoirs with outlet ports positioned on respective windshield wiper members 16 of a vehicle 12. The windshield cleaning apparatus 10 is particularly adapted for use with a vehicle 12 defining an engine compartment 14 and having a windshield, a pair of windshield wiper members 16, and a battery 18.

The first reservoir 20 may be a canister or similar housing that is configured to contain a traditional windshield cleaning fluid. Similarly, the second reservoir 24 may be a canister or similar housing that is configured to contain a deicing fluid. Each reservoir is sealed so as to contain a liquid without leaking. The first reservoir 20 and second reservoir 24 include a first input valve 22 and second input valve 26, respectively, configured to receive a refill of the respective liquid housed therein. It is understood that each fluid may be a liquid or a semi-fluid gel. Respective input valves are positioned atop respective reservoirs.

The reservoirs are configured to be positioned within an engine compartment 14 of a vehicle 12 such as an automobile. In one embodiment, the pair of reservoirs may be positioned adjacent one another under the hood of the vehicle 12 in a location easily accessible to a user (FIG. 1). It is understood that the first 20 and second 24 reservoirs may take the place of a traditional windshield cleaning fluid reservoir. In another embodiment, the reservoirs are positioned within a trunk compartment of a vehicle 12 and operatively coupled to a rear windshield wiper assembly (not shown).

Preferably, the first reservoir 20 contains a traditional windshield cleaning liquid therein. Traditional windshield cleaning fluid may be composed of one or more solvents with a detergent combined with water. Preferably, the second reservoir 24 contains a de-icing liquid that includes components to lower the freezing temperature of the mixture. More particularly, the deicing fluid may include methyl alcohol, ethylene glycol, or propylene glycol, all of which have chemical properties that lower the normal freezing temperature of water alone. In one embodiment, the deicing fluid includes methyl substituted Benzotriazole.

The windshield cleaning apparatus 10 includes a pump 30 operatively coupled to the first 20 and second 24 reservoirs. The pump 30 is electrically connected to the vehicle battery 18 and is selectively energized by electric current from the battery 18 as will be described in more detail later. The pump 30 is coupled to the first 20 and second 24 reservoirs and configured to exert a positive pressure to urge the fluid contents of each reservoir out, such as through respective outlet ports 40 when the pump is energized.

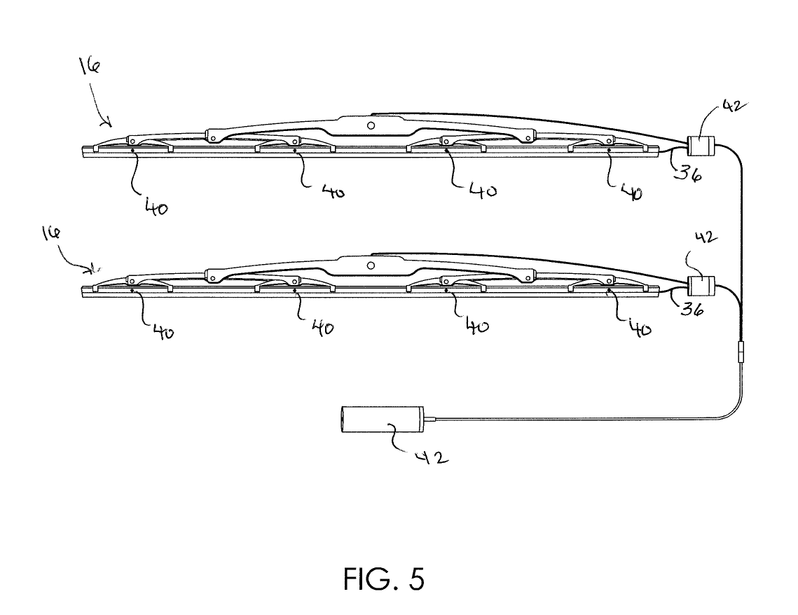

The windshield cleaning apparatus 10 includes at least one outlet port 40 (also known as an outlet nozzle) coupled to or positioned adjacent a respective windshield wiper member 16 of the vehicle 12 (FIG. 5). In an embodiment, a plurality of outlet ports 40 is spaced apart along each windshield wiper member 16. A respective outlet port 40 is configured to spray liquid from a respective reservoir onto the windshield of the vehicle 12 when the pump 30 is energized. In an embodiment, an outlet port includes a sprinkler head configured to broadly distribute a respective fluid onto the windshield when the pump is energized.

A tubing member 32 interconnects the first 20 and second 24 reservoir to the outlet ports 40. More particularly, the tubing member 32 includes a pair of first ends 34 in fluid communication with respective input valves 22, 26 of the first 20 and second 24 reservoirs. Similarly, the tubing member 32 includes a pair of second ends 36 in fluid communication with respective outlet ports 40. It is understood that various Y-shaped connectors may be used to cause the tubing member 32 to diverge to its respective ends. In addition, one or more hydraulic connectors 42 may be utilized to couple various segments of tubing to one another (FIG. 5).

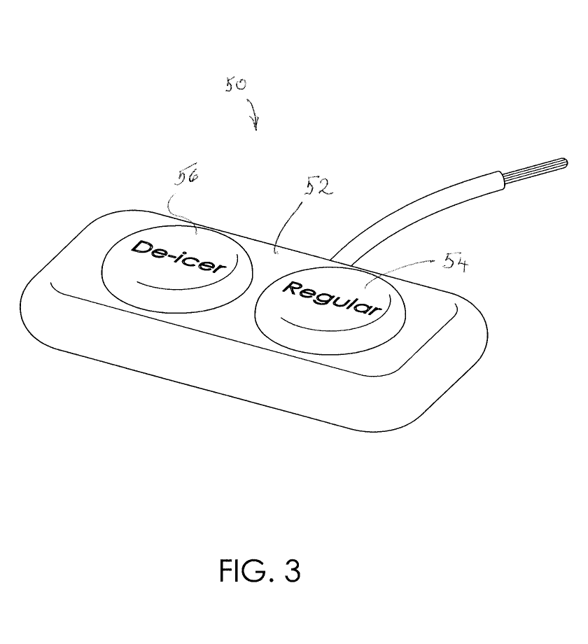

The windshield cleaning apparatus 10 includes an actuator 50 operatively connected to the pump 30 that causes the pump 30 to be energized to force respective fluids out of respective reservoirs into the tubing member 32. The actuator 50 may include an input device 52 configured to receive a user selection indicative of a desire to dispense liquid from the first reservoir 20 or from the second reservoir 24. More particularly, the input device 52 may include a pair of input buttons 54, 56 wherein one button has indicia indicative of the first reservoir 20 and wherein another button has indicia indicative of the second reservoir 24 (FIG. 3).

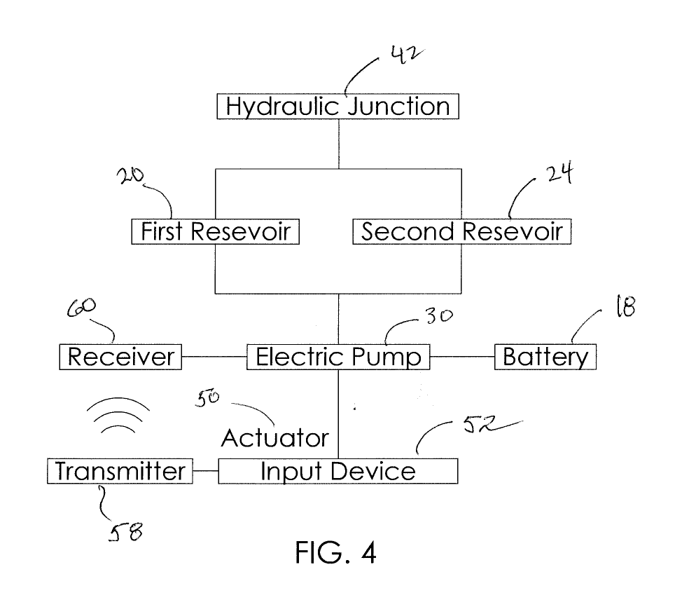

In one embodiment, the input device 52 may include electrical circuitry operatively connected to the input buttons 54, 56 and to the pump 30, the circuitry being configured to energize the pump 30 to force liquid to flow out of either the first reservoir 20 or the second reservoir 24 into the tubing member 32 depending on which button is actuated by the user (FIG. 4).

In another embodiment, the actuator 50 is essentially a remote control assembly that includes a transmitter 58 electrically connected to the input device 52 and includes a receiver 60 electrically connected to the electric pump 30 (FIG. 4). The transmitter 58 is configured to transmit a signal—such as a radio frequency (“RF”) signal—into the ambient air that is indicative of a user's selection of either the first reservoir 20 or the second reservoir 24. The receiver 60 is configured to energize the pump 30 to force liquid to flow out of either the first reservoir 20 or the second reservoir 24 into the tubing member 32 depending on which button is actuated by the user.

In use, the windshield cleaning apparatus 10 may be installed on a vehicle, such as a car or truck, such as by positioning the first reservoir 20 and second reservoir 24 within the engine compartment 14 and positioning the input device 52 within the passenger compartment. The first reservoir 20 may be filled with traditional windshield cleaning fluid and the second reservoir 24 may be filled with deicing fluid, as discussed above. Then, the driver of the vehicle may select which type of fluid is to be dispensed using the in-vehicle input device 52 to energize the pump 30 to dispense fluid from the selected reservoir. The pump 30 urges the fluid to flow through the tubing member 32 to the outlet ports 40 where it is dispensed onto the windshield, either to clean it or deice it.

It is understood that while certain forms of this invention have been illustrated and described, it is not limited thereto except insofar as such limitations are included in the following claims and allowable functional equivalents thereof.

1. A windshield cleaning apparatus for use with a vehicle having an engine compartment, a windshield, a pair of windshield wiper members, and a battery, said windshield cleaning apparatus, comprising:
a first reservoir positioned in the engine compartment of the vehicle and configured to contain a traditional windshield cleaning fluid;
a second reservoir positioned in the engine compartment of the vehicle and configured to contain a deicing fluid;
a pump electrically connected to the battery and operatively coupled to said first reservoir and to said second reservoir so as to selectively pump respective fluids out of respective reservoirs when energized by the battery;
an outlet port positioned proximate each windshield wiper member of the vehicle;
a tubing member interconnecting said first reservoir and said second reservoir with respective outlet ports and through which a respective fluid is urged when said pump is energized; and
an actuator electrically connected to the battery and configured to energize said pump to urge said respective fluid into said tubing member.

2. The windshield cleaning apparatus as in claim 1, wherein said actuator includes:
an input device configured to receive a user selection indicative of said first container or said second container;
a transmitter electrically connected to said input device and configured to transmit a signal into the ambient air;
a receiver in electrical communication with said pump and configured to actuate said pump upon receiving a signal from said transmitter.

3. The windshield cleaning apparatus as in claim 1, wherein said actuator is a remote control apparatus.

4. The windshield cleaning apparatus as in claim 3, wherein said remote control is configured to transmit a radio frequency (“RF”) signal to energize said pump.

5. The windshield cleaning apparatus as in claim 1, wherein said first reservoir includes an input valve configured to receive a refill of fluid into said first reservoir.

6. The windshield cleaning apparatus as in claim 1, wherein said second reservoir includes an input valve configured to receive a refill of fluid into said second reservoir.

7. The windshield cleaning apparatus as in claim 1, wherein said deicing fluid is selected from the group consisting of ethylene glycol, propylene glycol, and methyl alcohol.

8. The windshield cleaning apparatus as in claim 4, wherein said deicing fluid is selected from the group consisting of ethylene glycol, propylene glycol, and methyl alcohol.

9. The windshield cleaning apparatus as in claim 4, wherein said deicing fluid is selected from the group consisting of ethylene glycol, propylene glycol, and methyl alcohol.

10. The windshield cleaning apparatus as in claim 9, wherein deicing fluid includes methyl substituted Benzotriazole.

11. The windshield cleaning apparatus as in claim 1, wherein each outlet port is positioned in a respective windshield wiper member such that said traditional cleaning fluid and said deicing fluid are dispensed onto the windshield when said pump is energized.

12. The windshield cleaning apparatus as in claim 2, wherein each outlet port is positioned in a respective windshield wiper member such that said traditional cleaning fluid and said deicing fluid are dispensed onto the windshield when said pump is energized.

13. The windshield cleaning apparatus as in claim 12, wherein each outlet port includes a sprinkler head configured to broadly distribute a respective fluid onto the windshield when said pump is energized.

14. The windshield cleaning apparatus as in claim 1, wherein said tubing member includes a hydraulic connector.
